(19) United States
(12) Patent Application Publication
(10) Pub. No.: US 2013/0191181 A1
(43) Pub. Date: Jul. 25, 2013

(54) DETERMINING WHETHER TO LAUNCH A PARTICULAR OFFERING

(71) Applicants: Filippo Balestrieri, Mountain View, CA (US); Julie Ward Drew, Redwood City, CA (US)

(72) Inventors: Filippo Balestrieri, Mountain View, CA (US); Julie Ward Drew, Redwood City, CA (US)

(21) Appl. No.: 13/357,850

(22) Filed: Jan. 25, 2012

(51) Int. Cl. G06Q 30/02

(52) U.S. Cl. 705/7.32

(57) ABSTRACT

Survey responses are received regarding user interest in offerings of plural different types based on proposed incentives for the offerings of the plural different types. An analysis of the survey responses is performed. The analysis includes deriving measures based on the survey responses regarding user interest in the offerings of the plural different types, and computing, based on the measures, an indication of profitability regarding a particular one of the plural different types of offerings. The indication of profitability to allow for a determination of whether to launch the particular type of offering.

### BACKGROUND

An enterprise can offer various types of offerings for purchase, including products or services. In some examples, an enterprise may sell a service along with a particular product. An example of such a service is an extended warranty service.

### BRIEF DESCRIPTION OF THE DRAWINGS

Some embodiments are described with respect to the following figures:

FIG. 1 is a block diagram of an example arrangement that includes a survey system according to some implementations; and

FIGS. 2 and 3 are flow diagrams of survey processes according to some implementations.

### DETAILED DESCRIPTION

To increase profitability, an enterprise (e.g. a business concern, an educational organization, a government agency, and so forth) may decide to sell supplementary offerings along with “base” offerings. An “offering” can refer to a product or service. A “base” offering can refer to a product or service that is primarily offered by the enterprise for sale. A “supplementary” offering refers to an offering (in the form of a product or service) that can be sold as an option to customers along with a base offering. Alternatively, another type of offering is not tied to a base offering. As an example, a supplementary offering can include a warranty service, where the warranty service can refer to a service in which the enterprise agrees to remedy certain defects or issues that may arise in the base offering (e.g. a computer, a car, etc.). The warranty service can be an extended warranty service, which is a warranty service that extends a manufacturer's base warranty—the extended warranty service can extend the time duration, extend the coverage (to include additional types of coverage), and so forth.

As other examples, supplementary offerings can include technical support services (where the enterprise provides support to a customer to address various questions or issues that the customer may encounter), add-on features that can be added to the base offering (e.g. upgraded sound system for a car), or other types of offerings.

There can be different types of supplementary offerings. For example, a first type of supplementary offering can be a supplemental offering that is associated with a fixed temporal term of a particular length, which can be a relatively long length such as a year or more than a year. Examples of such longer-length fixed-term offerings include a fixed-term extended warranty service (where the warranty lasts for a predefined time interval that is paid for by a customer), a fixed-term technical support service (where technical support is offered for a predefined time interval), and so forth.

Another type of supplementary offering is an offering that is sold for a shorter time duration. The shorter-term offering provides greater flexibility to a customer, since the customer may have the option of cancelling the shorter-term offering after a smaller amount of time than would be possible with a longer term offering,. Examples of shorter-term flexible supplementary offerings include a shorter-term flexible warranty service, a shorter-term flexible technical support service, and so forth, each having a temporal term that is shorter than a traditional longer-term service. As examples, such shorter-term offerings can be implemented in at least the following two ways: 1) a customer has to actively renew the offering at the end of each (short) period; or 2) the customer agrees to receive the offering for an extended (possibly indefinite) time period and is offered the option of interrupting the offering at the end of every (short) period. In some specific cases, the “period” can be defined as a very short time interval (e.g. a day, an hour), such that implementation (2) is equivalent to a contract that can be terminated at will.

In other examples, there can be other types of offerings. For example, an enterprise may be currently selling a first type of offering in a multi-unit set (e.g. a set having some predefined number of units). The enterprise may be interested in a new type of offering that includes a smaller-size set (having a smaller number of units than the predefined number). Such a smaller-size set may also be considered to offer more flexibility to customers, since customers have the option of buying a smaller amount of the units.

Launching a new offering (e.g. shorter-term flexible offering or smaller-set flexible offering as noted above) can involve a substantial upfront investment in infrastructure by an enterprise. The infrastructure can include infrastructure to market the new offering, and infrastructure to support the new offering. For example, the enterprise may have to set up an information technology (IT) system to support the new offering, where the IT system can be used to verify whether a customer is entitled to the new offering, to track payments, and so forth. Personnel may also have to be hired to support the new offering.

If a new offering is launched by an enterprise and it turns out that the new offering is not as profitable as a current offering, then the enterprise may experience a financial loss due to the launch of the new offering. It can be difficult to predict whether any particular new offering would be profitable to an enterprise. In the case of a shorter-term flexible offering, it can be difficult to predict both the demand for the shorter-term flexible offering, and how long customers are likely to keep the offering. In the case of a smaller-set flexible offering, it can be difficult to predict both the demand for the smaller-set offering, and how many instances of the smaller-set flexible offering customers would likely be interested in over a given time period. Time can play a role in determining profitability of a smaller-set flexible offering, such as time related to an amount of time that a customer will take to consume a certain number of units in a first set, which may lead the customer to purchase another set. Such time of consumption may differ depending on the size of the bundle of units offered. Over a given time period (e.g. one year) the consumption of units may be different if the units are sold as bundles or un-bundled. The time of consumption may also be related to the price at which the different sets of offerings are marketed. In the present discussion, it is assumed that a determination can be made of a time period over which an average consumer consumes one offering coming from the first set (bundle) of units, and that this time period can be used as a time horizon to estimate the multi-unit demand of offerings from the second set.

In accordance with some implementations, a survey-based analysis system is provided to make a determination of whether or not a new type of offering (e.g. a shorter-term flexible offering or smaller-set flexible offering) is to be launched by an enterprise. In examples where the objective is to maximize profit, the launch of the new type of offering is considered in comparison with alternative strategies (e.g. different price for current offering).

In some implementations, the survey-based analysis system is able to identify the value of the flexibility provided by a flexible offering to users (as compared to a value that can be achieved by using an alternative strategy with respect to a current offering). In other implementations, the survey-based analysis system is able to identify the value of another feature of a particular offering. Such identification can be based on analysis of the responses by users to a specifically designed survey that is provided by the survey-based analysis system. For a shorter-term flexible offering, such as a shorter-term extended warranty service, responses by users regarding how long users are willing to keep such shorter-term flexible offering can be inaccurate. For example, when survey participants are asked directly regarding how long they plan to keep a shorter-term flexible offering, the responses may not be accurate since the survey participants may find it difficult to predict how long they intend to continue to keep the shorter-term flexible offering.

The survey-based analysis system according to some implementations does not have to rely on predictions by survey participants regarding duration of usage of a shorter-term flexible offering. In the context of a smaller-set flexible offering, the survey-based analysis system according to some implementations does not have to rely on predictions by survey participants regarding numbers of units that the survey participants may be interested in buying.

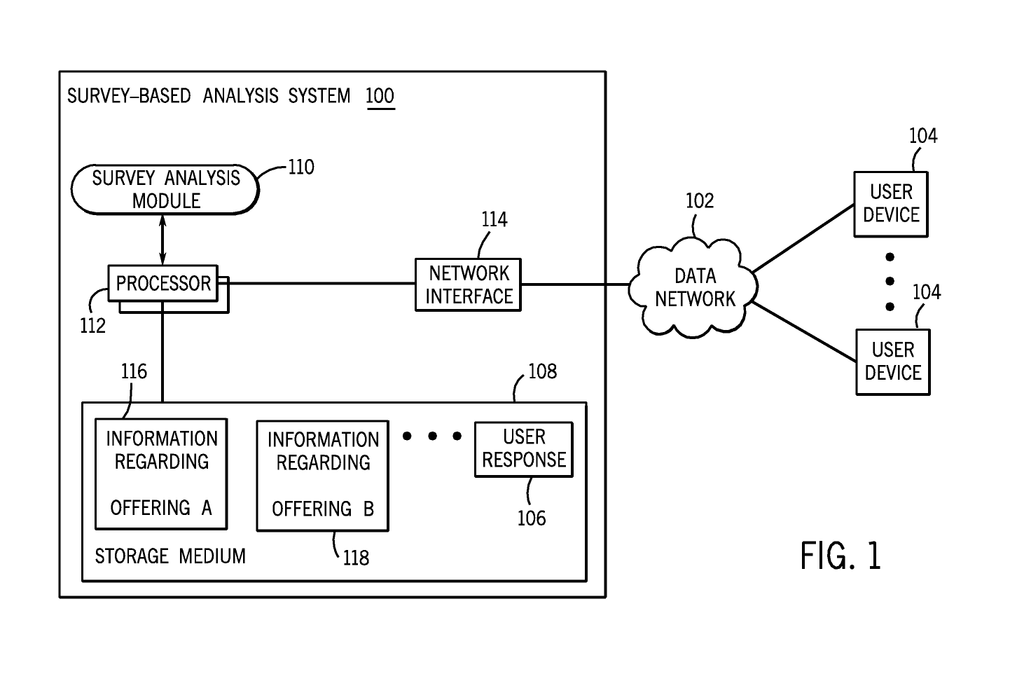

FIG. 1 depicts an example arrangement that includes a survey-based analysis system 100 according to some implementations. The survey-based analysis system 100 can be implemented as a computer or an arrangement of computers. The survey-based analysis system 100 is coupled over a data network 102 to various user devices 104. A survey can be conducted by the survey-based analysis system 100 by posing survey questions to the user devices 104, where users can provide their answers that are then communicated to the survey-based analysis system 100. User responses 106 are stored in a storage medium (or storage media) 108 in the survey-based analysis system 100.

The survey-based analysis system 100 includes a survey analysis module 110, which can be implemented as machine-readable instructions executable on one or multiple processors 112. The processor(s) 112 can be connected through a network interface 114 to the data network 102. In addition, the processor(s) 112 can be connected to the storage medium (or storage media) 108.

As further shown in FIG. 1, information regarding various offerings can also be stored in the storage medium (or storage media) 108. Such information includes information regarding offering A (116), information regarding offering B (118), and so forth. In some examples, offering A can be a longer-length fixed-term offering (e.g. longer-length fixed-term extended warranty service), and offering B can be a shorter-term flexible offering (e.g., shorter-term flexible extended warranty service). More generally, offerings A and B are considered different types of offerings that can be sold by an enterprise. Offering A can be an offering that is currently sold by the enterprise, while offering B is a new offering that the enterprise is considering launching. The survey-based analysis system 100 is used by the enterprise to decide whether or not to launch offering B, based on an estimate of profitability that is derived from responses to survey questions posed by the survey-based analysis system 100.

The methodology according to some implementations can include the following elements. A first element involves the drafting of survey questions to be included in a survey. These survey questions can be drafted by analysts, experts, or other personnel of an enterprise; as further examples, the survey questions can be received from an entity outside of the enterprise. A second element involves implementing the survey, which can be accomplished by the survey-based analysis system 100 sending the survey questions to user devices 104 for answer by survey participants. In other examples, implementation of the survey can involve manual collection of answers to survey questions. A third element involves the analysis of the survey responses that are responsive to the survey questions. Such analysis can be performed by the survey-based analysis system 100.

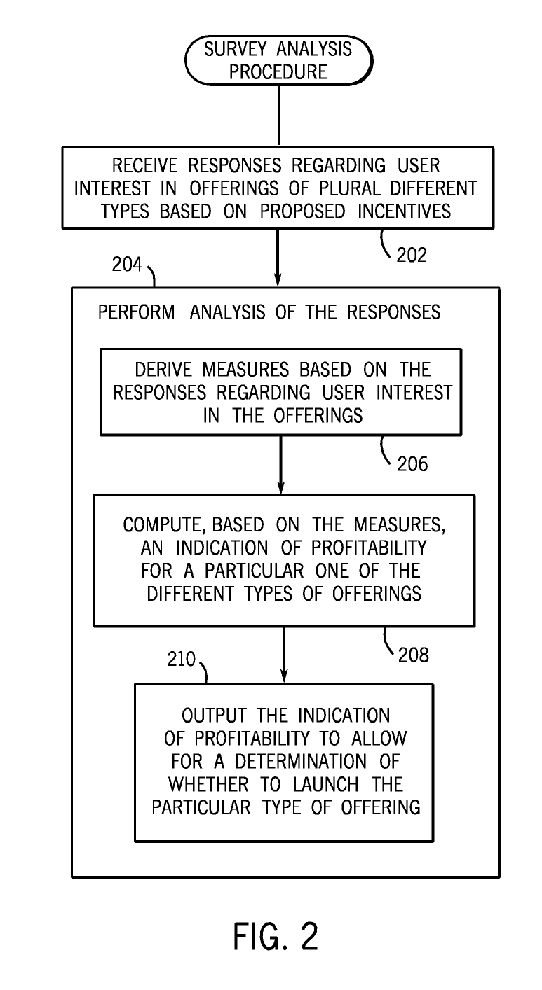

FIG. 2 is a flow diagram of a process performed by the survey analysis module 110, according to some implementations. The FIG. 2 process includes receiving (at 202) responses regarding user interest in offerings of plural different types based on proposed incentives (e.g. discounted prices or other types of incentives) for the supplemental offerings of the different types. For example, the different types of offerings can include offering A and offering B discussed above. Survey questions can be sent by the survey analysis module 110 to the user devices 104 regarding offerings A and B.

The survey questions based on proposed incentives for offering A are included in a set Q-A, while the survey questions based on proposed incentives for offering B are included in a set Q-B. In some examples, the proposed incentives include price discounts. The questions in Q-A ask survey participants whether the survey participants would be interested in purchasing offering A at various discounted prices (discounted from a regular market price of offering A). The set Q-A can include survey questions Q-A(1), Q-A(2), and so forth, where Q-A(1) is a survey question asking whether a survey participant would purchase offering A at discounted price pₜ(1), Q-A(2) is a survey question asking whether a survey participant would purchase offering A at discounted price pₜ(2), and so forth. More generally, Q-A(i), where i=1, 2, . . . , is a survey question asking whether a survey participant would purchase offering A at corresponding discounted price pₜ(i).

The questions in the set Q-B ask survey participants whether the survey participants would be interested in purchasing offering B at various discounted prices (corresponding to the discounted prices of offering A). The set Q-B can include survey questions Q-B(1), Q-B(2), and so forth, where Q-B(1) is a survey question asking whether a survey participant would purchase offering B at discounted price pₘ(1), Q-B(2) is a survey question asking whether a survey participant would purchase offering B at discounted price pₘ(2), and so forth. More generally, Q-B(i), where i=1, 2, . . . , is a survey question asking whether a survey participant would purchase offering B at corresponding discounted price pₘ(i).

If Q-A(1) is a survey question for a discounted price of offering A that reflects a 10% discount, Q-A(2) is a survey question for a discounted price of offering A that reflects a 20% discount, and so forth, then Q-B(1) is a survey question for a discounted price of offering B that reflects a 10% discount, Q-B(2) is a survey question for a discounted price of offering B that reflects a 20% discount, and so forth. In other words, the questions Q-A(i) and Q-B(i) reflect the same price discount that corresponds to index i--Q-A(1) and Q-B(2) reflect a first price discount, Q-A(2) and Q-B(2) reflect a second price discount, and so forth. The index i represents corresponding discounted price points.

Note that the pricing for offering A (which can be a fixed-term offering) can be for a time interval different from the time interval of offering B (which can be a flexible-term offering). As an example, the fixed-term offering A can be sold for an annual time interval (e.g. the price for offering A is $120 per year), whereas the flexible-term offering B can be sold for a monthly time interval (e.g. the price for offering B is $10 per month). In such a scenario, the discounted prices pₘ(i) are discounted prices at the time intervals for offering B. As an example, if pₜ(1)=$108 (for a year) is the discounted price at a 10% discount for offering A, then pₘ(1)=$9 (for a month) is the discounted price at a 10% discount for offering B. Stated differently, the discounted prices pₘ(i), i=1, 2, . . . , for offering B are prorated (due to differences in time intervals of respective offerings A and B) from the corresponding discounted prices pₜ(i), i=1, 2, . . . , for offering A.

Although reference is made to discounts as examples of proposed incentives that can be offered to the survey participants, it is noted that other incentives can also be proposed. For example, a different incentive can include providing additional products or services to a customer if the customer purchases a particular offering. Other example incentives can also be proposed, including any marketing incentive whose efficacy the enterprise would like to compare to the efficacy of adding flexibility to an offering.

In the foregoing examples, reference is made to two sets of questions, Q-A and Q-B, for respective two offerings A and B. More generally, there can be multiple (two or more) sets of questions for respective multiple offerings.

In addition to survey questions regarding offerings A and B, there can also be survey questions for profiling survey participants (e.g. determine demographics of participants, including age, gender, and so forth). Survey questions can also include benchmark questions (in a set Q-X) that ask whether the survey participants would purchase current offerings (e.g. offering A) at current one or more market prices (without any special incentives such as discounts).

In other examples, other types of questions can be posed to survey participants. Also, variations in the survey questions can be implemented to test framing effects, in which different text can be used in different survey questions to determine how such different text results in different survey responses.

The process of FIG. 2 next performs (at 204) an analysis of the survey responses received at 202. The analysis includes deriving (at 206) measures based on the responses regarding user interest in the offerings of the plural different types. The analysis further computes (at 208), based on the measures, an indication of profitability for a particular one of the different types of offerings. The indication of profitability can provide an indication of absolute financial gain or loss to the enterprise, or alternatively, the indication of profitability can provide an indication of a difference in profitability (such as a target increase in profitability) as compared to the profitability of a current offering. In some examples where the particular type of offering being considered is a shorter-term flexible offering, the indication of profitability can be represented by a duration that users have to continue to purchase the particular type of offerings to achieve profitability. Note that the duration does not provide a direct indication of profitability, but rather is an indirect indication of profitability, since the duration would be combined with other knowledge or information to ascertain the level of profitability as compared to a current offering. In other examples where the particular type of offering being considered is a smaller-set flexible offering, the indication of profitability can be represented by a number of instances of the smaller-set flexible offering that users would have to purchase to achieve profitability. Such number also provides an indirect indication of profitability.

More generally, the determined duration (for the shorter-term flexibly offering) or the determined number of instances of the smaller-set flexible offering is considered an amount of the flexible offering that users would have to purchase to achieve profitability (e.g. a target increase in profitability over a current offering).

The analysis then outputs (at 210) the computed indication of profitability, to allow for a determination of whether to launch the particular type of offering.

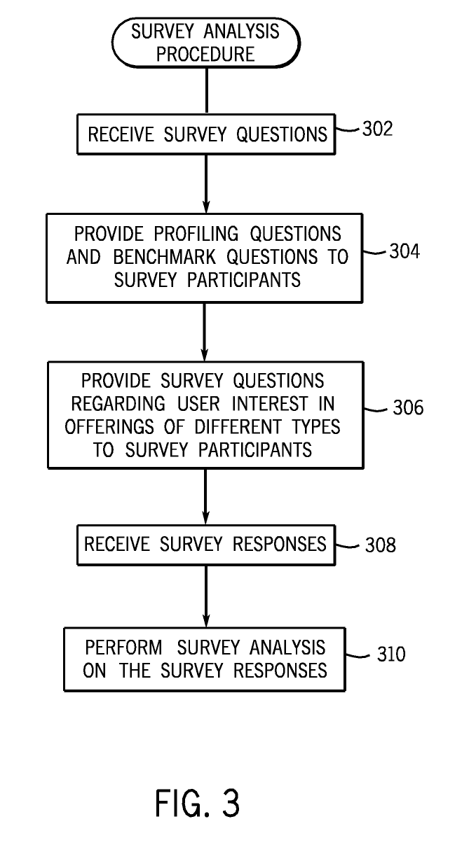

FIG. 3 is a flow diagram of a survey process according to further implementations. The survey-based analysis system 100 receives (at 302) survey questions drafted by personnel in an enterprise and/or personnel outside the enterprise. As noted above, these survey questions can include survey questions seeking participant responses regarding interest in purchasing different types of offerings with proposed incentives, such as the sets Q-A and Q-B of questions discussed above. The survey questions can also include questions for profiling participants, and benchmark questions (e.g. Q-X noted above).

The survey-based analysis system can provide (at 304) the profiling questions and the benchmark questions to every survey participant. However, in some examples, the questions in the sets Q-A and Q-B are provided (at 306) to selected survey participants (in other words, a given survey participant is presented with a survey question from set Q-A or Q-B, but not from both). The survey-based analysis system 100 can apply a randomization process to select a question from the sets Q-A and Q-B to present to the given survey participant.

The randomization process can be designed such that an equal number of survey participants is directed to each question Q-A(i) or Q-B(i). The randomization process can also ensure that the groups of survey participants directed to different questions are similar in terms of some demographic characteristic (e.g. age, gender, etc).

The survey-based analysis system 100 then receives (at 308) survey responses to the various survey questions. The survey-based analysis system 100 then performs (at 310) survey analysis on the collected survey responses. The survey analysis of 310 can be same as the survey analysis of 204 in FIG. 2.

The following describes further details regarding the survey analysis.

Price elasticity can be derived for a currently-offered offering (e.g. offering A), based on survey responses to questions in the benchmark set Q-X and survey responses to questions in the set Q-A. As noted above, the survey questions in the benchmark set Q-X ask whether the survey participants would purchase a current offering (e.g. offering A) at current one or more market prices (without any special incentives such as discounts). The survey responses to the benchmark questions that are of most interest are those that answer “no”—in other words, the corresponding survey participants are not interested in purchasing offering A at current market prices. The survey-based analysis system can count the number of participants who switch from expressing no interest in buying offering A at one or more market prices (responses to questions from Q-X) to expressing interest in buying offering A at a discounted price (responses to questions from Q-A(i)).

A demand switch measure is represented as the sum of survey participants who would switch from not buying offering A at market prices to buying offering A at discounted prices: Σᵢ SA(i). The parameter SA(i) represents a number of survey participants who would not buy offering A at market prices to buying offering A at a particular discounted price of interest pₜ(i), i=1, 2, . . . . More generally, SA(i) is a first measure that represents the number of survey participants who expressed interest in purchasing offering A relative to the number of survey participants who were asked if they are interested in offering A. This demand switch reflects price elasticity, which reflects responsiveness of the quantity demanded of a good or service to a change in its price. The summation Σᵢ SA(i) is performed for the following reason. Note that if there is interest in the switch due to reducing the price to level pₜ(k), then it makes sense to sum the number of survey participants who would switch to buying offering A at all discounted prices pₜ(j), where pₜ(j)≧pₜ(k). For example, if a customer would buy an offering for $10, then the customer would also buy the same offering for $8, $7, etc. What this means is that if it is desired to measure the total demand switch due to decreasing the price to $7 (pₜ(k)=7), then the technique adds up also the number of people who would switch at higher prices (i.e. pₜ(j)>pₜ(k)), such as $8 or $10.

A similar exercise is performed to calculate the demand switch measure of survey participants who expressed no interest in buying offering A at current one or more market prices (responses to questions from Q-X) to expressing interest in buying offering B at discounted prices (responses to questions from Q-B): Σᵢ SB(i) (which represents a sum of survey participants who would switch from not buying offering A at market prices to buying offering B at discounted prices). The parameter SB(i) represents a number of survey participants who would not buy offering A at market prices to buying offering B at a particular discounted price pₘ(i), i=1, 2, . . . . More generally, SB(i) is a second measure that represents the number of survey participants who expressed interest in purchasing offering B relative to the number of survey participants who were asked if they are interested in offering A.

Note that the demand switch measure Σᵢ SB(i) may not reflect price elasticity, since the demand switch may be due multiple factors: the change in price and the presence of a feature (e.g. flexibility in term) in offering B not found in offering A. A demand switch difference is calculated as Δ=Σᵢ SB(i)−Σᵢ SA(i). The demand switch computed according to the foregoing assumes that the same number of survey participants were presented with each question Q-B(i) as were presented with each question Q-A(i). If the foregoing assumption is not true, then weights can be applied to SB(i) and SA(i) based on the relative numbers of participants presented with corresponding questions Q-B(i) and Q-A(i).

Although reference is made to summing the number of participants who switch from not buying offering A at market prices to buying offering A or B at discounted prices to derive the measures Σᵢ SA(i) and Σᵢ SB(i), note that a different form of aggregating (e.g. averaging, weighted summing, etc.) can be used in other implementations. The measures SA(i), SB(i), Σᵢ SA(i), and Σᵢ SB(i) are examples of measures derived at 206 in FIG. 2.

If Δ<0, then that is an indication of reduced demand for offering B (as compared to the demand for offering A). This would indicate that launching offering B by an enterprise would not result in profitability. Thus, if Δ<0, then that is an indication to the enterprise that it would be better to not launch offering B, or to postpone the launch of offering B.

If Δ>0, then a feature of offering B (e.g. flexibility in term) has a positive impact in increasing demand for offering B (as compared to the demand for offering A). However, if offering B is a shorter-term flexible offering, then it is possible for a customer to cancel or stop purchasing offering B at any time (in which case the customer would pay only for the duration of offering B until cancellation). As a result, a demand increase indicated by Δ>0 may not lead to an increase in profits to the enterprise. In other words, even though there may be increased demand in offering B (as compared to offering A), such increased demand may not result in profitability to the enterprise if customers do not pay for offering B for sufficiently long durations.

If Δ>0, the survey-based analysis system 100 computes an indication of profitability, which can be the duration computed at 208 in FIG. 2. As discussed above, this duration is the duration that users would have to continue to pay for offering B to achieve profitability. In the ensuing discussion, this duration is represented as n.

The following calculates the corresponding price equivalent for each price point (i) between offerings A (e.g. longer-term fixed-term offering) and B (e.g. shorter-term flexible offering). For each discounted price point (i), Eq. 1 below identifies the number of periods, n(i), of offering B that customers have to pay for offering B to achieve profit equivalence with the scenario where only offering A is in the market:

pₘ(i)·n(i)·SB(i)=pₜ(i)·SA(i). (Eq. 1)

Eq. 1 can be rewritten as:

n(i)=pₜ(i)·SA(i)/pₘ(i)·SB(i). (Eq. 2)

The number of periods represented by n(i) corresponds to the number of periods contained in the time interval covered by the longer-length fixed-term offering. The demand for the longer-length fixed-term offering is assumed to be a unit demand. Over the time interval considered, a customer is expected to buy not more than one fixed-term offering. However, over the same time interval, the customer is expected to have a multi-unit demand for the shorter-term flexible offering.

As discussed above, pₜ(i) represents a discounted price for offering A at discounted price point i, and pₘ(i) represents a discounted price for offering B at discounted price point i.

If offerings A and B are sold with different time intervals, then the discounted prices pₘ(i) and pₜ(i) are scaled to reflect these different time intervals. For example, if offering A is sold on an annual basis, while offering B is sold with a monthly interval, then

pₘ(i)=pₜ(i)/12. (Eq. 3)

In this case, Eq. 2 can be rewritten as:

n(i)=12·SA(i)/SB(i). (Eq. 4)

The value of n(i) identifies a duration (e.g. number of months) that customers would have to continue to purchase offering B to achieve profit equivalence with offering A.

In an example where Eq. 4 is used, if n(i)>12 for most (greater than some predefined threshold number) of discounted price points (i), then launching offering B may not lead to increased profitability. The duration n(i)>12 for a given discounted price point (i) means that customers would have to continue purchasing offering B for greater than 12 months on average to allow the enterprise to achieve profit equivalence with offering B at the same discounted price point. Note that a similar approach can be used to compute the duration that would indicate a target level of profit increase relative to offering A.

For each discounted price point i, a corresponding value of n(i) is derived according to Eq. 4 (or Eq. 2). Thus, a first n(1) value is derived for discounted price point 1, a second n(2) value is derived for discounted price point 2, and so forth. If there is more than some predefined number of the n(i) values that exceeds a predetermined threshold, then that can be an indication that launching offering B may not lead to increased profitability.

On the other hand, if n(i) is relatively small (e.g. less than 4), then launching of offering B may lead to increased demand and increased profitability to the enterprise.

There is a range of values of n(i) for which the final decision on launching flexible services depend on the risk propensity of the enterprise. For a given value of n(i), the enterprise can use historical information (and other market data) to decide whether or not the benefit of launching offering B would outweigh the risk of launching offering B.

In examples where offerings A and B are multi-unit offerings of different sizes, then n(i) can represent the number of instances of offering B that customers would have to purchase to achieve profit equivalence with offering A. This applies over a given time period. The time period selected is such that an average consumer can be assumed to have unit-demand for the multi-unit bundled offering (in a set).

By employing survey analysis techniques or mechanisms according to some implementations, measures of profitability for a new offering can be obtained without having to first incur upfront investment costs. Also, such measures of profitability can be obtained without having to depend on the reliability of survey responses to duration-related questions.

Survey analysis techniques or mechanisms according to some implementations also reduces the impact of systematic bias present in survey participant responses to survey questions about hypothetical purchase situations. Survey participants often misrepresent or are incorrect about their intent to purchase an offering. For example, survey participants may tend to answer “yes” to questions regarding whether or not survey participants intend to purchase an offering at current market prices (benchmark questions in Q-X). The survey analysis techniques or mechanisms according to some implementations overcomes such inaccuracies in two ways. First, the analysis is performed using just responses of participants who answered “no” to the questions of Q-X; as a result, the analysis filters out responses that inflate purchase likelihood (e.g. the analysis can disregard survey participants who answered “yes” even though there is information indicating that such survey participants did not purchase the offering). Second, the analysis is based on the ratio of positive responses to two questions (SA(i)/SB(i)), rather than the absolute number of positive responses to any particular question. As such, systematic positive bias in the hypothetical purchase responses can be removed.

Machine-readable instructions of modules (such as the survey analysis module 110 of FIG. 1) are loaded for execution on a processor(s) (such as 110 in FIG. 1). A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1. A method, comprising:
receiving survey responses regarding user interest in offerings of plural different types based on proposed incentives for the offerings of the plural different types; and
performing, by a computer, an analysis of the survey responses, the analysis comprising:
deriving measures based on the survey responses regarding user interest in the offerings of the plural different types, the derived measures including a first measure based on a number of users who expressed interest in purchasing a first of the plural different types of offerings, and a second measure based on a number of users who expressed interest in purchasing a second of the plural different types of offerings;
computing, based at least on a relationship between the first and second measures, an indication of profitability regarding the second type of offering; and
outputting the indication of profitability to allow for a determination of whether to launch the second type of offering.

2. The method of claim 1, wherein computing the indication of profitability comprises computing the indication of profitability over a given time period.

3. The method of claim 1, wherein computing the indication of profitability comprises computing a duration that users would have to continue to pay for the second type of offering to achieve profitability.

4. The method of claim 3, wherein computing the duration is based on a ratio between the first measure and the second measure, where the ratio is the relationship.

5. The method of claim 4, wherein deriving the first measure is based on a count of a number of users who stated they would not purchase the first type of offering at one or more current prices but that would purchase the first type of offering with a corresponding proposed incentive, and
wherein deriving the second measure is based on a count of a number of users who stated they would not purchase the first type of offering at the one or more current prices but that would purchase the second type of offering with a corresponding proposed incentive.

6. The method of claim 5, further comprising computing a difference between a first value based on the first measure and a second value based on the second measure, wherein the difference provides an indication of whether an increase in demand would result if the second type of offering were launched.

7. The method of claim 3, further comprising using the duration to determine whether or not to launch the second type of offering.

8. The method of claim 1, wherein the offerings of the plural different types include a longer-term offering and a shorter-term flexible offering, and wherein the second type of offering is the shorter-term flexible offering.

9. The method of claim 1, wherein the offerings of the plural different types include a larger-set offering and a smaller-set flexible offering, and wherein the second type of offering is the smaller-set flexible offering.

10. The method of claim 1, further comprising:
receiving survey questions to present to users, wherein the survey questions are divided into different sets of survey questions for respective different ones of the plural different types of offerings,
wherein the survey responses are responsive to the survey questions.

11. An article comprising at least one non-transitory machine-readable storage medium storing instructions that upon execution cause a system to:
receive survey responses regarding user interest in offerings of plural different types based on proposed incentives for the offerings of the plural different types; and
perform an analysis of the survey responses, the analysis comprising:
deriving measures based on the survey responses regarding user interest in the offerings of the plural different types, the derived measures including a first measure based on a number of users who expressed interest in purchasing a first of the plural different types of offerings, and a second measure based on a number of users who expressed interest in purchasing a second of the plural different types of offerings;
computing, based at least on a relationship between the first and second measures, an amount of the second type of offering that users would have to purchase to achieve profitability increase over the first type of offering;
outputting the computed amount as an indication of profitability, to allow for a determination of whether to launch the second type of offering.

12. The article of claim 11, wherein the instructions upon execution cause the system to further:
receive survey questions to present to users, wherein the survey questions are divided into different sets of survey questions for respective different ones of the plural different types of offerings,
wherein the survey responses are responsive to the survey questions.

13. The article of claim 12, wherein the instructions upon execution cause the system to further:
randomly present different survey questions from the sets to different ones of the users.

14. The article of claim 12, wherein the instructions upon execution cause the system to further:
present each of the survey questions from the sets to a same number of users.

15. The article of claim 11, wherein computing the amount is based at least in part on a ratio between the first measure and the second measure, where the ratio is the relationship.

16. The article of claim 15, wherein deriving the first measure is based on a count of a number of users who stated they would not purchase the first type of offering at one or more current prices but that would purchase the first type of offering with a corresponding proposed incentive, and
wherein deriving the second measure is based on a count of a number of users who stated they would not purchase the first type of offering at the one or more current prices but that would purchase the second type of offering with a corresponding proposed incentive.

17. The article of claim 11, wherein the proposed incentives include proposed discounted prices.

18. A system comprising:
at least one processor to:
receive survey responses regarding user interest in offerings of plural different types based on proposed incentives for the offerings of the plural different types; and
perform an analysis of the survey responses, the analysis comprising:
deriving measures based on the survey responses regarding user interest in the offerings of the plural different types, the derived measures including a first measure based on a number of users who expressed interest in purchasing a first of the plural different types of offerings, and a second measure based on a number of users who expressed interest in purchasing a second of the plural different types of offerings;
computing, based at least on a relationship between the first and second measures, an indication of profitability regarding the second type of offering; and
outputting the indication of profitability to allow for a determination of whether to launch the second type of offering.

19. The system of claim 18, wherein the proposed incentives include proposed discounted prices.
